(19) United States
(12) Patent Application Publication
(10) Pub. No.: US 2011/0080641 A1
(43) Pub. Date: Apr. 7, 2011

(54) Diffraction Toy System

(75) Inventor: Peter Sgromo, Alameda, CA (US)

(73) Assignee: IMPERIAL TOY LLC, North Hills, CA (US)

(21) Appl. No.: 12/898,561

(22) Filed: Oct. 5, 2010

Related U.S. Application Data
(60) Provisional application No. 61/249,099, filed on Oct. 6, 2009.

(51) Int. Cl. G02B 27/42

(52) U.S. Cl. 359/567

(57) ABSTRACT

A diffraction toy system comprises an optical viewing device that provides a diffraction optical viewing effect. The viewing devices can be a pair of eyeglasses having diffraction lenses. The system includes a child's play object that includes a light source. The play object can be nonwearable or wearable objects that can accommodate a light source, such as toy cars, trucks, swords, hats, belts, tiaras, and the like. The light source can be a light emitting diode, and the light source can emit colored light. The play object can be a light device that produces a light show. The system can include a number of viewing devices worn by multiple users, and the viewing devices can provide the same or a different diffusion optical effect. Backdrops, with or without light sources, can be includes to provide a further enhanced visual effect.

### CROSS-REFERENCE TO RELATED APPLICATIONS

This patent application claims priority from U.S. Provisional Patent Applications 61/249,099 filed on Oct. 6, 2009, which is herein incorporated by reference in its entirety.

### FIELD OF THE INVENTION

This invention relates to a diffraction toy system which comprises a diffraction viewer, a device or toy that includes a light source and optionally other accessories and props that may be used as part of a themed package for creating a virtual or fantasy environment or game. The light diffraction properties of the diffraction viewer provides participant(s) an enhanced visual perception of the device or toy.

### SUMMARY OF THE INVENTION

In one embodiment, a diffraction toy system is disclosed. The diffraction toy system comprises a diffraction viewer and a device or toy that includes a light source. The diffraction viewer is preferably provided as a pair of eyeglasses which may be worn by a user. The diffraction viewer comprises a frame and a lens having a diffraction grating or lens. The device or toy may be any kind of object that can accommodate a light source, such as toy cars, trucks, swords, hats, belts, tiaras, and the like. The light source provided on the device or toy may be an incandescent, fluorescent, or an electric light bulb or, preferably, a light-emitting diode. The light source may be provided in any number of colors.

In another embodiment, a virtual reality environment or game is provided utilizing the diffraction toy system. The virtual reality environment or game may be incorporated as part of a single- or multi-player game and may include scene or themed backdrops which may be supported by a wall or a separate support structure. Additional props may be provided to further enhance the virtual or fantasy environment. The scene backdrops and props may further include individual sources of lights embedded thereon, such that participant(s) wearing the diffraction viewer are provided with a further enhanced visual experience. In a multi-player game, multiple players may be equipped with glasses, each optionally having different diffraction properties.

A more complete understanding of system and methods disclosed herein will be afforded to those skilled in the art, as well as a realization of additional advantages and objects thereof, by a consideration of the following detailed description. Reference will be made to the appended sheets of drawings which will first be described briefly.

### BRIEF DESCRIPTION OF THE DRAWINGS

FIG. 1 depicts a preferred embodiment of a diffraction toy system including a diffraction viewer, a toy with a light source and play instructions.

FIG. 2 depicts a preferred embodiment of a diffraction viewer.

Throughout the several figures and in the specification that follows, like element numerals are used to indicate like elements appearing in one or more of the figures.

### DETAILED DESCRIPTION OF THE PREFERRED EMBODIMENTS

Disclosed herein are diffraction toy systems and methods for using the same for creating a virtual and fantasy environment or game. The diffraction toy system provides a user with an enhanced visual experience when used in connection with a device or toy having a specially equipped light source. The diffraction toy system may further be used in connection with a themed or fantasy game or environment involving single or multiple players.

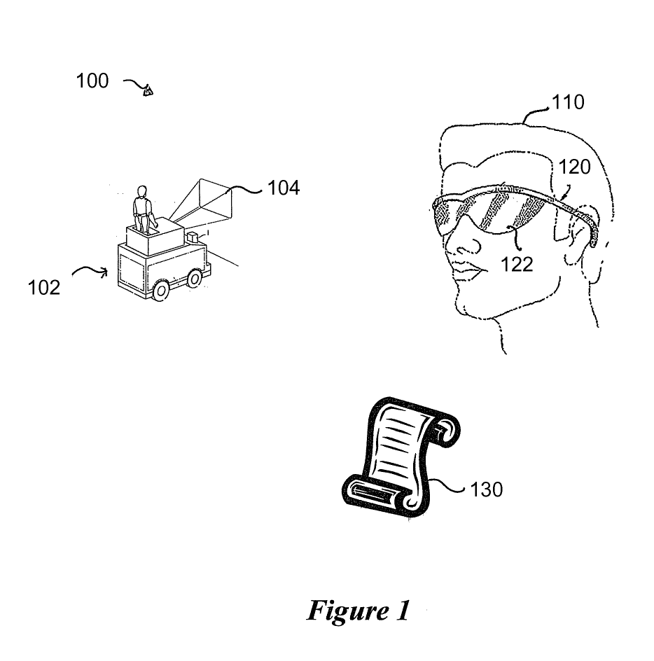

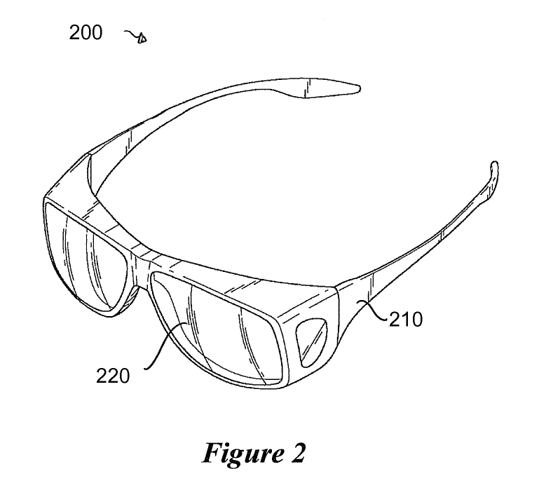

FIG. 1 depicts a preferred embodiment of a diffraction toy system 100. The diffraction toy 100 generally comprises a diffraction viewer 120 that is worn by a user 110. The diffraction viewer 120 is preferably configured as a pair of eyeglasses having a diffraction lens or grating 122 which is configured to diffract or split light into its spectral components. As further shown in FIG. 2, the diffraction eyeglasses 200 comprises a diffraction grating or lenses 220 which may be fitted within the frame 210 of the eyeglasses 200. The diffraction eyeglasses 200 may optionally be provided with a plurality of interchangeable lenses each having a different diffractive property or characteristic. Suitable diffraction eyeglasses are known in the art and may be used in connection with the system.

A toy or device 102 is further provided with the diffraction toy system 100. It is understood that the toy or device 102 may be any object capable of supporting a light source 104. The toy or device thus may further include a power source (not shown). In a preferred embodiment, the power source is one or more batteries

The light source 104 may be any object that is capable of emitting light and may be any one or a combination of an incandescent, fluorescent and/or electric light bulb, a light-emitting diode (LED), or a chemiluminescent light source (which does not require a power source). Preferably, the light source is a LED or other similar source which does not emit a significant amount of heat with the generation of the light. The light source may be provided in any number of colors available. In one embodiment, a variety of different types of light sources in a variety of different colors may be provided on a single or on multiple toys so as to provide different diffractive results when viewed through the diffraction viewer 120.

The diffraction toy system may be used in connection with single- or multi-player games. To that end, the diffraction toy system 100 may be provided with game instructions or rules 130 and other props and accessories (not shown), such as a scene or themed backdrops which may be supported by a wall or other support structure. The scene backdrops may further include any one or a combination of light sources embedded thereon, such that participant(s) wearing the diffraction viewer are provided with a further enhanced visual experience. In a multi-player game, multiple players may be equipped with glasses, each optionally having different diffraction properties.

In yet another embodiment, the diffraction toy system may comprise a light device that incorporates one or more light sources and is configured to provide and display a light show. The light device may be viewed by multiple participants, each equipped with a diffraction viewer. Each participant may be provided with the same or different diffraction viewer. Because diffraction viewers may be configured with lenses or gratings having different diffractive properties, providing participants with different diffraction viewers allows the players to have a unique viewing experience of the light device.

Having thus described preferred embodiments for a diffraction toy system, it should be apparent to those skilled in the art that certain advantages of the within methods and systems have been achieved. It should also be appreciated that various modifications, adaptations, and alternative embodiments thereof may be made without departing from the scope and spirit of the present technology.

What is claimed is:

1. A diffraction optical effect play system comprising:
a viewing device that provides a diffraction optical effect; and
a children's play object comprising a light source attached thereto;
wherein when the play object is viewed through the viewing device, the viewer sees a diffraction optical effect that provides an enhanced visual experience.

2. The system as recited in claim 1 wherein the viewing device comprises a pair of eyeglasses having lenses that include the diffraction optical effect.

3. The system as recited in claim 2 wherein the lenses are interchangeable to provide different diffraction optical effects.

4. The system as recited in claim 2 wherein the play object can be configured as any object capable of accommodating the light source.

5. The system as recited in claim 4 wherein the play object is selected from the group consisting of non-wearable objects and wearable objects.

6. The system as recited in claim 5 wherein the play object is selected from the group consisting of toy cars, toy trucks, toy swords, hats, belts and tiaras.

7. The system as recited in claim 1 wherein the light source is selected from the group consisting of incandescent, fluorescent and light-emitting diode.

8. The system as recited in claim 1 wherein the light source emits a colored light.

9. The system as recited in claim 1 further comprising a portable backdrop having themed or scenic artistry.

10. The system as recited in claim 9 wherein the backdrop includes a light source.

11. The system as recited in claim 1 wherein the play object is a light device comprising one or more light source to display a light show.

12. The system as recited in claim 11 comprising a number of viewing devices each worn by a different user.

13. The system as recited in claim 12 wherein one or more of the viewing devices provide a different diffraction optical effect.

14. A diffraction optical effect play system comprising:
a pair of eyeglasses having lenses that provide a diffraction optical viewing effect; and
a child's play toy accommodating one or more light emitting diodes;
wherein when viewed by a user through the viewing device, the play toy provides a diffraction optical effect that provides an enhanced visual experience.

15. The system as recited in claim 14 wherein the lenses are interchangeable to provide different diffraction optical effects.

16. The system as recited in claim 14 wherein the play toy is selected from the group consisting of toy cars, toy trucks, toy swords, hats, belts and tiaras.

17. The system as recited in claim 14 wherein the light emitting diode emits a colored light.

18. The system as recited in claim 14 further comprising a portable backdrop having themed or scenic artistry.

19. The system as recited in claim 18 wherein the backdrop includes a light source.

20. A method for creating a diffraction optical effect from a child's play object toy comprising the steps of:
providing a child's play object comprising a light source; and
wearing eyeglasses having lenses that provide a diffraction optical effect; and
viewing the play object;
wherein the light sources as viewed through the eyeglasses provide an enhanced visual experience.

21. The method as recited in claim 20 wherein the play object comprises a toy and the light source comprises a light emitting diode.

22. The method as recited in claim 20 wherein the play object comprises a light device that displays a light show.

23. The method as recited in claim 22 comprising a number of eyeglasses worn by different users, wherein the lenses in the eyeglasses can provide the same or different diffraction optical viewing effect.

24. The method as recited in claim 20 further comprising providing a backdrop having themed or scenic artistry.

25. The method as recited in claim 24 wherein the backdrop includes a light source.
